(19) United States
(12) Patent Application Publication
(10) Pub. No.: US 2002/0157419 A1
(43) Pub. Date: Oct. 31, 2002

(54) Sol-gel process for producing synthetic silica glass

(76) Inventors: Rahul Ganguli, Camarillo, CA (US); Enrico C.J. Westenberg, Camarillo, CA (US)

Correspondence Address: SHEPPARD, MULLIN, RICHTER & HAMPTON LLP, 333 SOUTH HOPE STREET, 48TH FLOOR, LOS ANGELES, CA, 90071-1448, US

(21) Appl. No.: 10/137,098

(22) Filed: May 1, 2002

Related U.S. Application Data
(63) Continuation of application No. 09/516,688, filed on Mar. 1, 2000, now abandoned.

(51) Int. Cl. C03B 8/02

(52) U.S. Cl. 65/17.2

(57) ABSTRACT

An improved sol-gel process is disclosed for producing a synthetic silica glass article, in which a sol is formed having a silica loading as high as 34 to 40%. This high loading is achieved by introducing an aqueous colloidal silica suspension into a silicon alkoxide solution and slowly stirring the mixture together, during which time the mixture hydrolyzes and the colloidal suspension is broken down by chemical reaction. This produces a hydrolyzed sol incorporating a suspension of very fine aggregates of colloidal particles, having particle sizes less than about 10 microns. The need for a stabilizing agent and/or continuous ultra-sonicating or violently stirring the sol is eliminated.

### BACKGROUND OF THE INVENTION

This invention relates generally to sol-gel processes for making articles of silica glass and, more particularly, to sol-gel processes that utilize both an alkoxide precursor and a suspension of colloidal particles.

Sol-gel processes are useful for making articles of synthetic silica glass having shapes close to that desired for the final product. This reduces costs associated with machining and polishing the articles. Typically, sol-gel processes involve steps of (1) synthesizing a liquid silica solution, or sol, typically by hydrolyzing an alkoxide precursor or stabilizing a colloidal silica solution, (2) condensing the sol to yield a wet gel, (3) aging the wet gel to strengthen it, (4) drying the wet gel to produce a dry gel, and (5) sintering the dry gel to yield a dense glass article.

The gels yielded by this sol gel route typically are quite porous, with large pore (void) volumes and relatively low volume loading of silica. Because the porous gels are later sintered into dense glass articles, the large void volumes bring about a large amount of shrinkage during the sintering step and thus yield silica articles of reduced size. It therefore follows that reducing the void volume will increase the amount of sintered silica glass that can be obtained from a single processing cycle and thus reduce manufacturing costs. Increasing the loading of silica in the sol is one way to achieve this.

Three distinct processes have been used in the past to produce silica sols. One such process uses pure alkoxide precursors, but it typically yields a silica loading of only about 17 to 20%. A second such process uses colloidal silica in lieu of pure alkoxides. This latter process yields higher silica loading, but it requires stabilizing agents to be incorporated into the glass matrix. This can add to the cost of the process and can degrade the quality of the resultant glass.

A third process used in the past to produce silica sols uses a combination of an alkoxide and colloidal silica. Specifically, a hybrid colloidal silica/alkoxide sol is produced by adding fumed silica powder to an already hydrolyzed alkoxide of silica. The hydrolyzed alkoxide is produced initially by mixing together water and silica alkoxides, e.g., tetra-ethoxysilane (TEOS), which are initially immiscible but which dissolve into each other when an alcohol reaction product is generated in sufficient quantity. Thus, hydrolysis is initiated and carried out by adding acidic water to an alkoxide and stirring the resulting mixture. After hydrolysis has been completed, the fumed silica powder, e.g., Aerosil OX-50, is added and the solution is violently stirred.

In this third process, the addition of a large amount of fumed silica powder to the hydrolyzed alkoxide solution typically yields a non-homogeneous sol incorporating large particles of aggregated silica powder and TEOS. These particles can weaken the resulting gel, which can lead to cracking during the drying stage. This problem can be overcome by adding the fumed silica powder only with continuous ultra-sonication and by centrifuging the solution to remove aggregated particles, but this can add to the cost of the process.

It should be appreciated from the foregoing description that there remains a need for a sol-gel process for producing a gel having a high loading of silica, so that larger volumes of silica glass can be produced, without the added expense and inconvenience of requiring a stabilizing agent and/or significant additional processing equipment or steps. The present invention fulfills this need.

### SUMMARY OF THE INVENTION

The present invention resides in an improved sol-gel process for producing a synthetic silica glass article, in which a sol is formed having a high loading of silica without the need for a stabilizing agent and without the need for significant additional processing equipment or steps such as continuous ultra-sonication or violent nixing of the sol. More particularly, the process includes forming a sol by introducing an aqueous colloidal suspension into an organic silicon alkoxide solution and then allowing the organic silicon alkoxide to hydrolyze into a sol containing fine aggregates of silica particles. The sol then undergoes gelation, to form a wet gel, which is in turn dried and sintered to produce a dense glass article. By mixing the colloidal suspension with the alkoxide solution before hydrolysis has occurred, the suspended particles are broken down by chemical reaction. The agglomeration of the colloidal particles into particulates of excessive size, e.g., greater than about 10 microns, is avoided.

In a preferred application of the process, the aqueous colloidal suspension includes fumed silica powder, e.g., Aerosil OX-50 or Aerosil 200. When Aerosil OX-50 is used, its mole ratio to water preferably is in the range of about 1:4 to 1:8, and most preferably about 1:5. The sol has a silica loading of greater than about 20%, and preferably in the range of about 34 to 40%. The organic silicon alkoxide solution can take the form of a tetra-alkoxy-silane, preferably tetraethoxysilane, tetramethoxysilane, tetrapropoxysilane, and mono- and bi-substituents of such silanes. The mole ratio of the silicon alkoxide to water in the sol preferably is in the range of about 1:4 to 1:20, and most preferably about 1:6 to 1:10.

Alternatively, the aqueous colloidal suspension can incorporate titania, zirconia, erbia, alumina, or combinations thereof, or it can include colloidal metal particles or colloidal particles of glass and/or metal having an outer coating of gold, silver, rhodia, platinum, or combinations thereof.

Other features and advantages of the present invention should become apparent from the following detailed description of the preferred process, which discloses by way of example the principles of the invention.

### DETAILED DESCRIPTION OF THE PREFERRED PROCESS

The preferred process of the invention efficiently produces high quality silica glass articles of increased size, without the added expense and inconvenience of requiring special stabilizing agents and/or additional processing equipment or steps in the sol synthesis stage. In the process, high loadings of colloidal particles, e.g., fumed silica powder, are added to an acidic water medium, to produce an aqueous slurry. This slurry then is added to a silicon alkoxide solution and the mixture is slowly stirred together, during which time the silicon alkoxide hydrolyzes and the slurry is broken down by chemical reaction. This produces a hydrolyzed sol incorporating a suspension of very fine aggregates of colloidal particles.

By mixing the colloidal particle slurry with the alkoxide before hydrolysis has occurred, agglomeration of the colloidal particles into particulates of excessive size is avoided without the need for special measures such as violent shaking, continuous ultra-sonication, or adding of special stabilizing agents. The process of the invention can achieve substantially higher loadings by weight over what can be achieved using a standard pure alkoxide process.

A sol that is homogeneous is considered necessary for the production of a gel having the desired strength and uniformity. Experimental data indicates that the maximum particle size that can be tolerated in such a sol is about 10 microns. The process of the invention produces a sol having this characteristic, with reduced expense and process complexity.

One factor that contributes to the creation of a sol having the desired high loading is the weight ratio of the colloidal particles to water. Generally, the higher this ratio, the smaller the size of the colloidal aggregates in the final sol. This is considered counter-intuitive and contrary to previous teachings. In the past, higher fumed silica loading has been associated with massive precipitated particles, requiring centrifugation.

In one particularly preferred application of the process of the invention, the colloidal particles take the form of Aerosil OX-50, a common fumed silica powder. Using the process of the invention, sols having silica loadings in the range of 34 to 40% can be achieved. This is roughly double what can be achieved using a standard pure alkoxide process. In this preferred process, the mole ratio of the OX-50 powder to water in the aqueous colloidal suspension is preferably in the range of about 1:4 to about 1:8, and most preferably about 1:5. The organic silicon alkoxide solution preferably comprises a tetra-alkoxy-silane such as tetraethoxysilane, tetramethoxysilane, tetrapropoxysilane, and mono- and bi-substituents of such silanes. The mole ratio of the tetra-alkoxy-silane to water in the sol preferably is in the range of about 1:4 to about 1:20, and most preferably in the range of about 1:6 to about 1:10.

Alternatively, the aqueous colloidal suspension can incorporate other forms of fumed silica (e.g., Aerosil 200), titania, zirconia, erbia, alumina, or combinations thereof, or alternatively it can incorporate colloidal metal particles or colloidal particles of glass and/or metal having an outer coating of gold, silver, rhodia, platinum, or combinations thereof.

The process of the invention can be better understood by reference to the following illustrative examples.

### EXAMPLE 1

About 72 grams of Aerosil OX-50 silica powder was slowly added to about 108 grams of acidified de-ionized water at a pH of 2.0, to form a viscous paste. The paste's OX-50:H₂O mole ratio was about 1:5. The acid was selected from hydrochloric acid (HCl), nitric acid (HNO₃), acetic acid (CH₃COOH), sulfuric acid (H₂SO₄), and combinations thereof. About 208 grams of tetra-ethoxysilane (TEOS) was added to this paste, to produce a two-phase mixture having a TEOS:H₂O mole ratio of about 1:6. After about 90 minutes of slow mixing, the mixture became a clear, white, single-phase solution, or sol. This sol was ultra-sonicated for about 5 minutes and then centrifuged for about 30 minutes at 3000 g. No settling was observed, and the sol easily flowed through 10-micron sieve filter paper.

At this stage, the silica loading of the sol was about 34% silica by weight. The median particle size, as observed by diluting the sol in alcohol and measuring with a Horiba L-900 laser particle size analyzer, was 1.75 microns (see Table 1). Depending on the end application, the sol could be further concentrated, using an evaporating device, to achieve 50% by weight of silica (a volume reduction of about 36%, carried out at 60° C. and reduced pressure). This mixture did not settle when centrifuged at 3000 g for 20 minutes. The mixture is flowable for casting and is free of any stabilizing agents.

This sol can then be gelled, dried and sintered according to methods described in the prior art, to yield high quality synthetic silica glass.

TABLE 1

| | Median particle size |
|---|---|
| Example | (microns) |
| 1 | 1.75 |
| 2 | 6.5 |
| 3 | 25.5 |
| 4 | 35.0 |
| 5 | 250 to 1000 |
| 6 | 1.75 |
| 7 | 40 |

### EXAMPLE 2

About 120 grams of Aerosil OX-50 powder was slowly added to 180 grams of deionized water at a pH of 2.0, to form a viscous paste. The paste's Si:H₂O mole ratio was about 1:5. About 208 grams of TEOS was added to this paste, providing a two-phase mixture having a TEOS:H₂O mole ratio of about 1:10. This mixture was then slowly mixed together and, after about 90 minutes, a clear, white, single-phase liquid was produced. This single-phase liquid was ultra-sonicated for 5 minutes and then centrifuged for 30 minutes at 3000 g. No settling was observed, and the sol flowed smoothly through a filter paper of 10-micron mesh size. The median particle size, as observed by diluting the sieved sol in alcohol and measuring with a Horiba L-900 laser particle size analyzer, was 6.5 microns (see Table 1). In this example, the silica loading of the mixture was about 35% silica by weight.

### EXAMPLE 3

About 60 grams of Aerosil OX-50 powder was slowly added to about 180 grams of deionized water at a pH of 2.0, to form a viscous paste. The paste's Si:H₂O mole ratio was about 1:10. About 208 grams of TEOS was added to this paste, providing a two-phase mixture having a TEOS:H₂O mole ratio of about 1:10. This mixture was then slowly mixed together and, after about 90 minutes, a clear, white, single-phase liquid was produced. This single-phase liquid was ultra-sonicated for 5 minutes and then centrifuged for 30 minutes at 3000 g. Some settling was observed, and the mixture failed to flow smoothly through a filter paper of 10-micron mesh size. This mesh filter screened out about 5 to 25% by mass of the silica. In this example, the silica loading of the mixture typically was in the range of about 18.5 to 22.0% silica by weight.

The median particle size, as observed by diluting the sieved sol in alcohol and measuring with a Horiba L-900 laser particle size analyzer, was 25.5 microns (see Table 1). This is substantially larger than the desired median particle size of less than about 10 microns. This example reveals the detrimental effect of reducing the mole ratio of Aerosil OX-50 silica powder to water to a value less than about 1:8.

### EXAMPLE 4

About 300 grams of Aerosil OX-50 powder was slowly added to about 450 grams of deionized water at a pH of 2.0, to form a viscous paste. The paste's Si:H₂O mole ratio was about 1:5. About 208 grams of TEOS was added to this paste, providing a two-phase mixture having a TEOS:H₂O mole ratio of about 1:25. This mixture was then slowly mixed together and, after about 90 minutes, a clear, white, single-phase liquid was produced. This single-phase liquid was ultra-sonicated for 5 minutes and then centrifuged for 30 minutes at 3000 g. Some settling was observed, and the liquid failed to flow smoothly through a filter paper of 10 microns mesh size.

The median particle size, as observed by diluting the sieved sol in alcohol and measuring with a Horiba L-900 laser particle size analyzer, was 35 microns (see Table 1). This is substantially larger than the desired median particle size of less than about 10 microns. This example reveals the detrimental effect of having a TEOS:water mole ratio of less than 1:20.

### EXAMPLE 5

About 24 grams of Aerosil OX-50 powder was slowly added to about 36 grams of deionized water at a pH of 2.0, to form a viscous paste. The paste's Si:H₂O mole ratio was about 1:5. About 208 grams of TEOS was added to this paste, providing a two-phase mixture having a TEOS:H₂O mole ratio of about 1:2. This mixture was then slowly mixed together, but a single-phase liquid never was attained. Instead, the mixture was grainy and incorporated a collection of particles about 250 to 1000 microns in diameter (see Table 1). This mixture was centrifuged for 30 minutes at 3000 g, and all of the particles appeared to settle out. The mixture failed to flow smoothly through a filter paper of 10-micron mesh size.

This sol was unacceptable. This example reveals the detrimental effect of having a TEOS:water mole ratio greater than 1:4.

### EXAMPLE 6

About 72 grams of Aerosil OX-50 powder was slowly added to about 108 grams of deionized water at a pH of 2.0, to form a viscous paste. The paste's Si:H₂O mole ratio was about 1:5. About 208 grams of TEOS was added to this paste, providing a two-phase mixture having a TEOS:H₂O mole ratio of about 1:6. This mixture was then slowly mixed together and, after about 90 minutes, a clear, white, single-phase liquid was produced. This single-phase liquid was ultra-sonicated for 5 minutes and then centrifuged for 30 minutes at 3000 g. The liquid flowed smoothly through a filter paper of 10-micron mesh size.

At this stage of the process, the sol's silica loading was about 34% silica by weight. The mixture was further concentrated by evaporating alcohol under reduced pressure at about 60° C. About 116 grams of ethanol was evaporated to provide a final silica loading of 48.5% by mass. This resultant sol smoothly flowed through filter paper with a 10-micron mesh size. The median particle size, as observed by diluting the sieved sol in alcohol and measuring with a Horiba L-900 laser particle size analyzer, was 1.75 microns (see Table 1). No settling was observed when this sol was centrifuged for 30 minutes at 3000 g. As in all the other examples, no stabilizing agents were used.

This example shows that higher silica loadings, up to about 50% by mass, can be prepared by evaporation of the chemically mixed sol.

### EXAMPLE 7

About 72 grams of Aerosil OX-50 powder was slowly added to about 108 grams of de-ionized water at a pH of 2.0, to form a viscous paste. The paste's Si:H₂O mole ratio was about 1:5. The paste was ultra-sonicated for about 5 minutes and then diluted in alcohol and slowly stirred. The median particle size of this solution was then analyzed using the Horiba L900 particle size analyzer and observed to be 40 microns (see Table 1).

In this example, the agglomerate size of the Aerosil OX-50 powder in an aqueous solution was significantly larger than the acceptable size of about 10 microns. Comparison with Examples 2, 3 and 6 indicates than the hydrolysis reaction of these previous Examples is effective in reducing the agglomerate size of the OX-50 particles to an acceptable level, i.e., less than 10 microns in size.

It should be appreciated from the foregoing description that the present invention provides an improved sol-gel process for producing a synthetic silica glass article, in which a sol is formed having a silica loading as high as 34 to 40%. This high loading is achieved by introducing an aqueous colloidal suspension into a silicon alkoxide solution and the mixture is slowly stirred together, during which time the mixture hydrolyzes and the colloidal suspension is broken down by chemical reaction. This produces a hydrolyzed sol incorporating a suspension of very fine aggregates of colloidal particles, having particle sizes less than about 10 microns. The need for a stabilizing agent and/or continuous ultra-sonicating or violently stirring the sol is eliminated.

Although the invention has been described in detail with reference only to the presently preferred process, those of ordinary skill in the art will appreciate that various modifications can be made without departing from the invention. Accordingly, the invention is defined only by the following claims.

We claim:

1. A process for producing a synthetic silica glass article, comprising:
combining an aqueous colloidal suspension with a silicon alkoxide solution to produce a mixture;
allowing the mixture to hydrolyze into a sol containing fine aggregates of colloidal particles and then to gel into a wet gel;
drying the wet gel to produce a dry gel; and
sintering the dry gel to produce a dense silica glass article.

2. A process as defined in claim 1, wherein the aqueous colloidal suspension includes fumed silica powder.

3. A process as defined in claim 2, wherein the fumed silica powder is Aerosil OX-50 powder having a mole ratio to water in the aqueous colloidal suspension in the range of about 1:4 to about 1:8.

4. A process as defined in claim 3, wherein the mole ratio of Aerosil OX-50 powder to water in the aqueous colloidal suspension is about 1:5.

5. A process as defined in claim 2, wherein:
the sol has a silica loading of greater than about 20%; and
the gel is substantially free of agglomerated colloidal silica particles having a particle size greater than about 10 microns.

6. A process as defined in claim 5, wherein the sol has a silica loading in the range of about 34% to about 40%.

7. A process as defined in claim 1, wherein:
the sol is free of a stabilizing agent; and
the process is free of steps of violently mixing the sol and/or continuously ultra-sonicating the sol.

8. A process as defined in claim 1, wherein the aqueous colloidal suspension comprises titania, zirconia, erbia, alumina, or combinations thereof.

9. A process as defined in claim 1, wherein the aqueous colloidal suspension comprises colloidal metal particles.

10. A process as defined in claim 1, wherein the aqueous colloidal suspension comprises colloidal particles of glass and/or metal having an outer coating of gold, silver, rhodia, platinum, or combinations thereof.

11. A process as defined in claim 1, wherein the organic silicon alkoxide solution comprises a tetra-alkoxy-silane.

12. A process as defined in claim 11, wherein the mole ratio of the silicon alkoxide to water in the sol is in the range of about 1:4 to about 1:20.

13. A process as defined in claim 11, wherein the mole ratio of the silicon alkoxide to water in the sol is in the range of about 1:6 to about 1:10.

14. A process as defined in claim 11, wherein the tetra-alkoxy-silane comprises tetraethoxysilane, tetramethoxysilane, tetrapropoxysilane, and mono- and bi-substituents of such silanes.

15. A process for producing a synthetic silica glass article, comprising:
forming a mixture of silicon alkoxide, colloidal silica, and water, wherein the mixture is substantially free of a stabilizing agent and has a silica loading greater than about 30%, and wherein forming is performed without continuous ultra-sonicating or violently mixing the mixture;
allowing the mixture to hydrolyze into a sol containing fine aggregates of silica particles and substantially free of agglomerated colloidal silica particles having a particle size greater than about 10 microns, and then allowing the sol to gel into a wet gel;
drying the wet gel to produce a dry gel; and
sintering the dry gel to produce a dense silica glass article.

16. A process as defined in claim 15, wherein:
forming includes
forming an aqueous colloidal suspension,
forming an organic silicon alkoxide solution, and
mixing the aqueous colloidal suspension with the organic silicon alkoxide solution;
the aqueous colloidal suspension includes Aerosil OX-50 fumed silica powder in a mole ratio to water in the range of about 1:4 to about 1:8;
the organic silicon alkoxide solution comprises a tetra-alkoxy-silane in a mole ratio to water in the range of about 1:4 to about 1:20; and
the sol has a silica loading in the range of about 34% to about 40%.

17. An article made according to the process of claim 1.
